(19) United States
(12) Patent Application Publication
(10) Pub. No.: US 2026/0054418 A1
(43) Pub. Date: Feb. 26, 2026

(54) MEASURING SEAT FOR SINTERED STONE CUTTING MACHINE

(71) Applicant: Hui-Chuan LIAO, Oakland, CA (US)

(72) Inventor: Hui-Chuan LIAO, Oakland, CA (US)

(21) Appl. No.: 18/814,240

(22) Filed: Aug. 23, 2024

(51) Int. Cl. B28D 7/04; B28D 1/24

(52) U.S. Cl. CPC B28D 7/04; B28D 1/24

(57) ABSTRACT

A measuring seat for a sintered stone cutting machine is disposed on a sintered stone cutting machine and has a positioning arm. The sintered stone cutting machine has a track base and a cutter. The cutter is movably disposed on the track base and has a cutting wheel. The positioning arm extends outwardly and downwardly adjacent to a bottom of the track base, is located at a same side of the track base as the cutting wheel, and has a reference board formed on a free end of the positioning arm. The reference board has an external side face. An imaginary extension line of the external side face of the reference board is in a straight line with a cutting edge of the cutting wheel.

### BACKGROUND OF THE INVENTION

### 1. Field of the Invention

The present invention relates to a measuring seat, and more particularly to a measuring seat for a sintered stone cutting machine that is convenient for measurement and safe to use.

### 2. Description of Related Art

Building materials such as glass, tiles, and sintered stones often need to be cut into corresponding shapes and sizes according to users' needs. Among them, sintered stone is a high-hardness plate made of natural materials through vacuum extrusion and high-temperature sintering, and has characteristics of anti-wear, scratch resistance, high temperature resistance, and environmental protection, etc. Therefore, sintered stones are commonly used in the fields of construction, decoration, furniture, etc. Since the sintered stones are high-hardness slabs, the requirements for cutting accuracy and stability are higher than those of glass and tiles, so they cannot be used with ordinary cutting machines and need to be matched with a cutting machine for sintered stones.

A conventional sintered stone cutting machine has a track base, a cutter, and multiple suckers. The track base is elongated. The cutter is movably disposed on the track base and has an operating shaft and a cutting wheel. The operating shaft is swingably disposed on the cutter and is located on one side of the track base. The cutting wheel is located below the cutter and is connected to the operating shaft. Then the cutting wheel can be moved relative to the track base by the operating shaft. The multiple suckers are connected to the track base and are located on the other side of the track base. When the conventional sintered stone cutting machine is in use, the track base is disposed on a top of a processed sintered stone and is moved relative to the processed sintered stone according to a cutting location. After moved to the cutting location, the track base can be held securely on the processed sintered stone by the multiple suckers adsorbed to the top of the processed sintered stone. Then a user can hold and swing the operating shaft to move the cutting wheel toward the processed sintered stone, as the operating shaft moves, the cutting wheel abuts against the processed sintered stone. With the movement of the operating shaft relative to the track base, the cutting wheel forms a cutting line on the processed sintered stone, and the operation of the conventional sintered stone cutting machine is completed.

However, the conventional sintered stone cutting machine can provide a cutting effect to the processed sintered stone, when measuring the cutting position for the processed sintered stone, the user needs to extend fingers to the cutting wheel to measure the actual cutting location. Since the cutting wheel is located below the operating shaft, this is not only inconvenient to measure, but also often injuries the user's fingers due to the sharp edge of the cutting wheel, and raises safety concerns. Furthermore, although the conventional sintered stone cutting machine can be easily assembled and disassembled on the processed sintered stone by the multiple suckers, after long-term use, the materials of the multiple suckers are easily affected by material changes, which affects the adsorption strength and stability of the multiple suckers to the processed sintered stone. Then the track base cannot be stably held on the processed sintered stone, and this will affect the accuracy of the subsequent cutting of the conventional sintered stone cutting machine to the processed sintered stone. The conventional sintered stone cutting machine has the above-mentioned problems and deficiencies and needs improvement.

The measuring seat for a sintered stone cutting machine in accordance with the present invention mitigates or obviates the aforementioned problems.

### SUMMARY OF THE INVENTION

The main objective of the present invention is to provide a measuring seat for a sintered stone cutting machine that is convenient for measurement and safe to use.

The measuring seat for a sintered stone cutting machine in accordance with the present invention is disposed on a sintered stone cutting machine and has a positioning arm. The sintered stone cutting machine has a track base and a cutter. The cutter is movably disposed on the track base and has a cutting wheel. The positioning arm extends outwardly and downwardly adjacent to a bottom of the track base, is located at a same side of the track base as the cutting wheel, and has a reference board formed on a free end of the positioning arm. The reference board has an external side face. An imaginary extension line of the external side face of the reference board is in a straight line with a cutting edge of the cutting wheel.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a measuring seat for a sintered stone cutting machine in accordance with the present invention;

FIG. 2 is a perspective side view of the measuring seat for a sintered stone cutting machine in FIG. 1;

FIG. 3 is a cross sectional side view of the measuring seat for a sintered stone cutting machine in FIG. 1;

FIG. 4 is a perspective view of the measuring seat for a sintered stone cutting machine in FIG. 1, mounted on a sintered stone cutting machine;

FIG. 5 is an enlarged perspective view of the measuring seat for a sintered stone cutting machine in FIG. 4;

FIG. 6 is a top side view of the measuring seat for a sintered stone cutting machine in FIG. 5;

FIG. 7 is an enlarged and exploded perspective view of the measuring seat for a sintered stone cutting machine in FIG. 5;

FIG. 8 is a cross sectional side view of the measuring seat for a sintered stone cutting machine in FIG. 5;

FIG. 9 is an enlarged and operational perspective view of the measuring seat for a sintered stone cutting machine in FIG. 5, mounted on a processed sintered stone;

FIG. 10 is an enlarged perspective view of the measuring seat for a sintered stone cutting machine in FIG. 9;

FIG. 11 is another enlarged perspective view of the measuring seat for a sintered stone cutting machine in FIG. 9;

FIG. 12 is an enlarged, operational, and cross sectional side view in partial section of the measuring seat for a sintered stone cutting machine in FIG. 9;

FIG. 13 is an enlarged and operational top side view of the measuring seat for a sintered stone cutting machine in FIG. 9;

FIG. 13A is an enlarged and operational top side view of the measuring seat for a sintered stone cutting machine in FIG. 13;

FIG. 13B is another enlarged and operational top side view of the measuring seat for a sintered stone cutting machine in FIG. 13; and

FIG. 14 is an enlarged and operational top side view of the measuring seat for a sintered stone cutting machine in FIG. 9.

### DETAILED DESCRIPTION OF THE PREFERRED EMBODIMENT

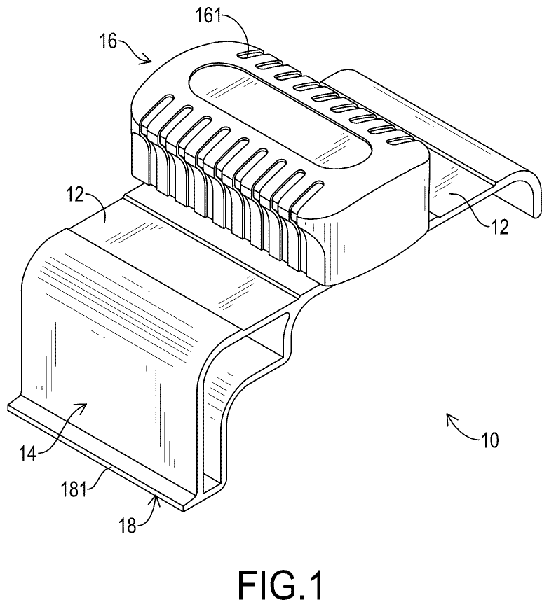

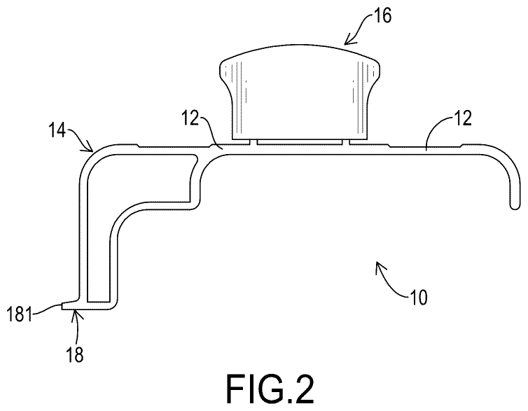

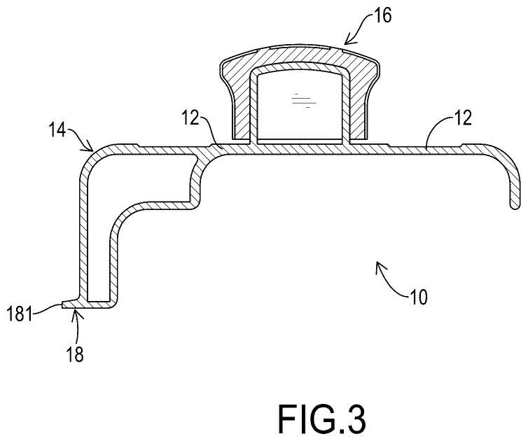

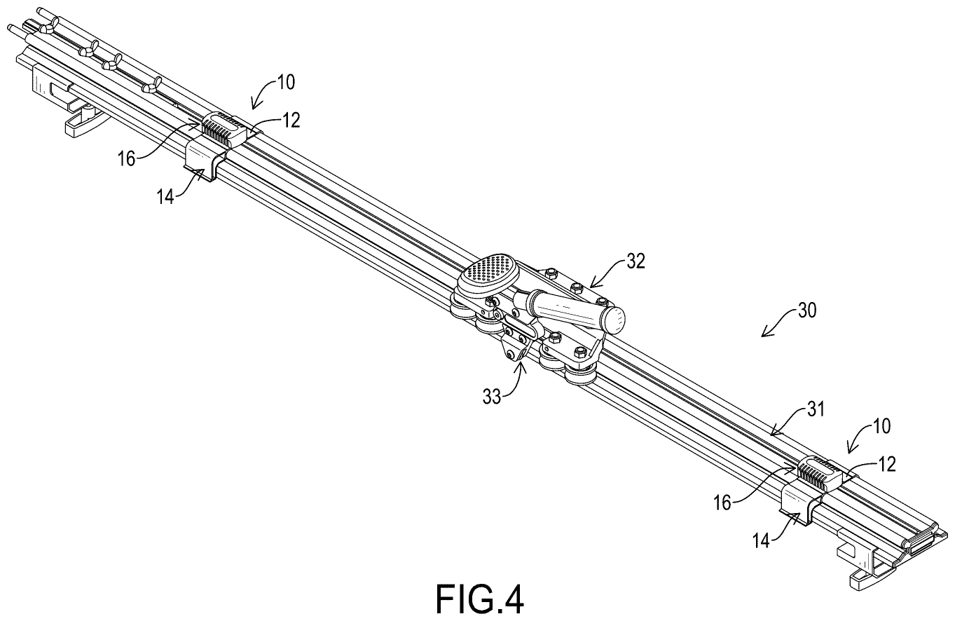

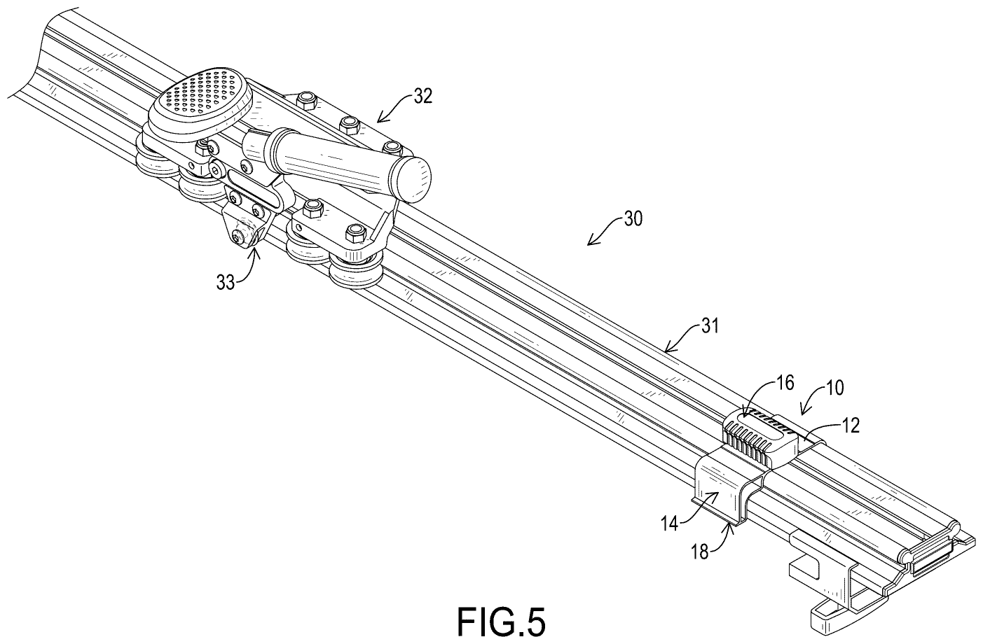

With reference to FIGS. 1 to 5, a measuring seat 10 for a sintered stone cutting machine in accordance with the present invention is disposed on a sintered stone cutting machine 30 and has two engaging arms 12, a positioning arm 14, and a pushing stem 16. The sintered stone cutting machine 30 has a track base 31 and a cutter 32. The cutter 32 is movably disposed on the track base 31 and has a cutting wheel 33. Preferably, there are two said measuring seats 10 respectively disposed on two ends of the track base 31.

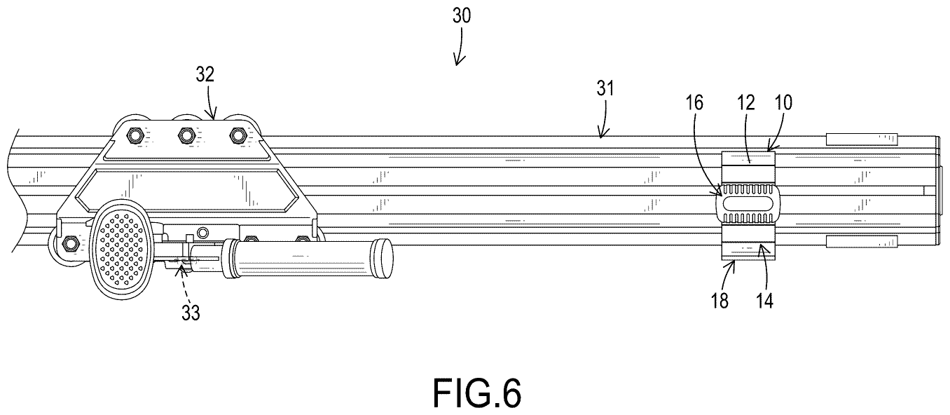

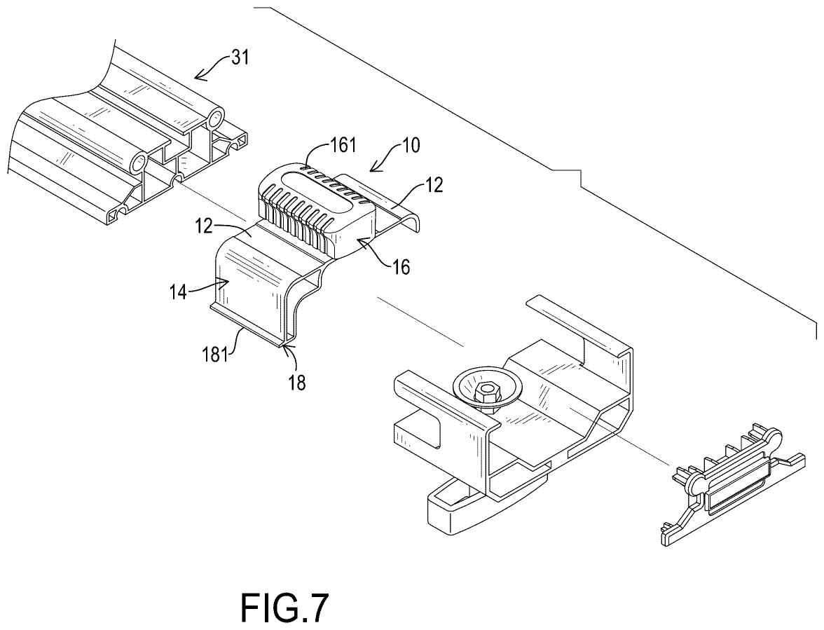

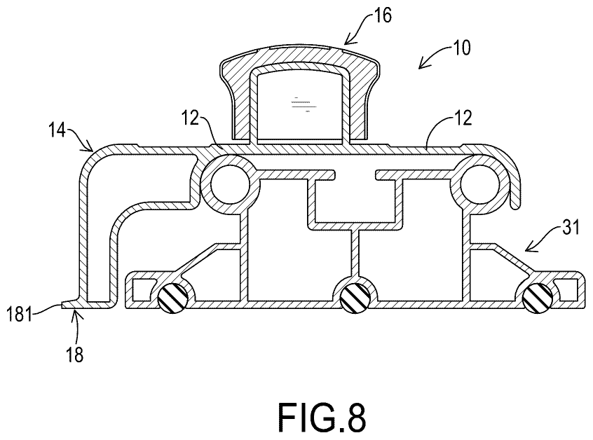

With reference to FIGS. 6 to 8, the two engaging arms 12 of each one of the two measuring seats 10 are connected to each other, extended in opposite directions, and are connected to the track base 31 to dispose the measuring seat 10 on the track base 31.

The positioning arm 14 is connected to one of the two engaging arms 12, and extends outwardly and downwardly adjacent to a bottom of the track base 31. The positioning arm 14 and the cutting wheel 33 are located on a same side of the track base 31. The positioning arm 14 has a reference board 18 transversally formed on a free end of the positioning arm 14. Furthermore, the reference board 18 extends along a width direction of the track base 31 and has an external side face 181. With reference to FIG. 6, an imaginary extension line of the external side face 181 of the reference board 18 is in a straight line with a cutting edge of the cutting wheel 33. That is, a cutting line formed by the cutting edge of the cutting wheel 33 is located on the same straight line as the external side face 181 of the reference board 18.

The pushing stem 16 is disposed on a top of the measuring seat 10 between the two engaging arms 12, and this enables users to move the measuring seat 10 relative to the track base 31 by pushing the pushing stem 16. Preferably, the pushing stem 16 has multiple notches 161 formed on an outer side of the pushing stem 16 to increase contact area and friction between the user's hand and the pushing stem 16, allowing the user to push the measuring seat 10 easily and conveniently.

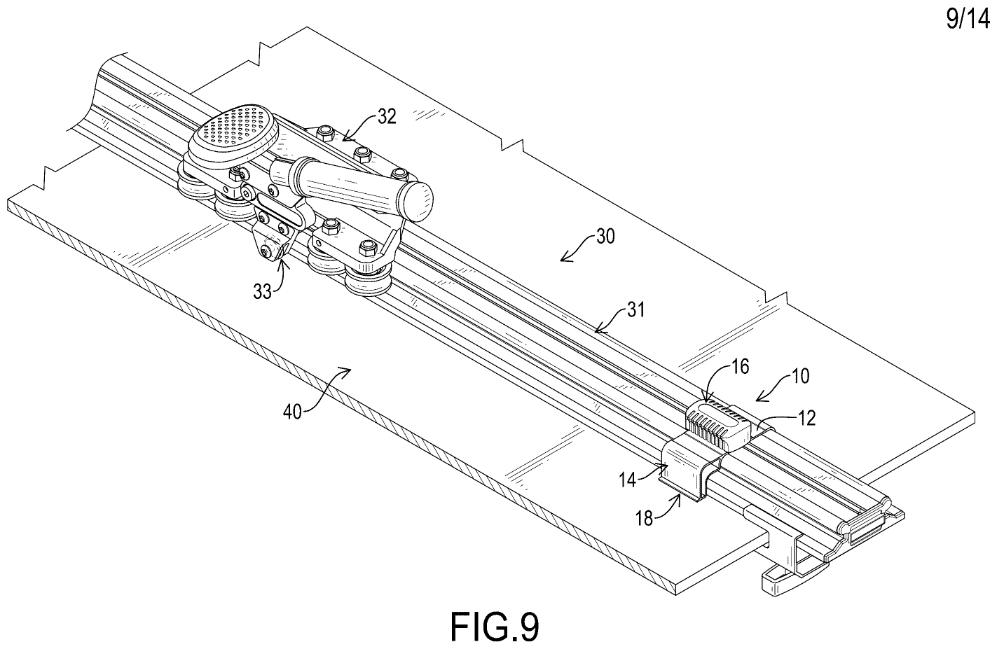

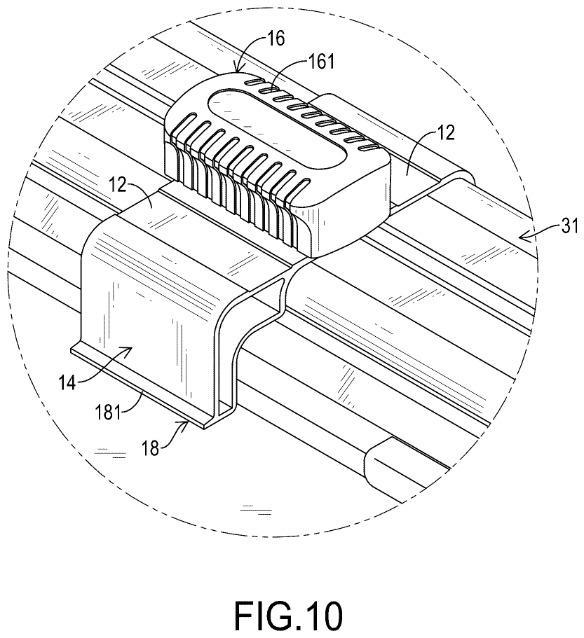

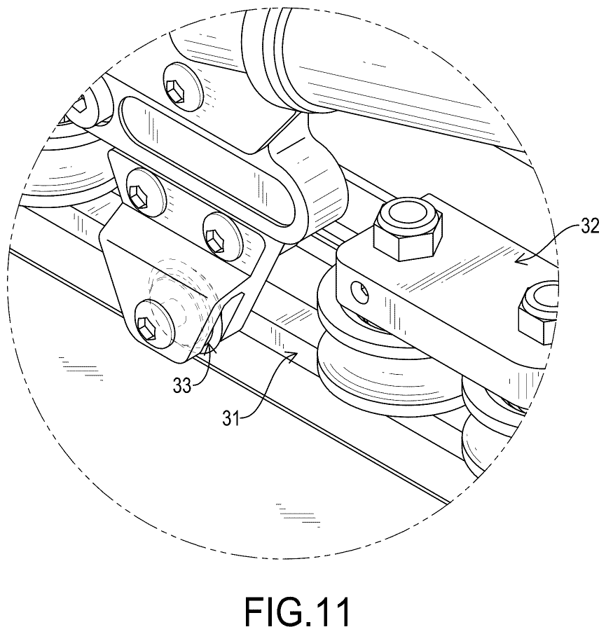

With reference to FIG. 9, when the measuring seat 10 for a sintered stone cutting machine of the present invention is in use, firstly, the track base 31 is disposed on a processed sintered stone 40, at this time, with reference to FIGS. 10 and 11, since the external side face 181 of the reference board 18 of the positioning arm 14 of each of the two measuring seats 10 and the cutting edge of the cutting wheel 33 are located on the same straight line, when a user wants to measure the position for cutting size of the processed sintered stone 40, the user no longer needs to insert fingers to the cutting edge of the cutting wheel 33, but can use the external side face 181 of the reference board 18 of each measuring seat 10 as the position for cutting size of the processed sintered stone 40, and this not only can measure the position for cutting size of the processed sintered stone 40 conveniently and accurately, but also can avoid injuries caused by contact with the cutting edge of the cutting wheel 33, and greatly improve the safety of use.

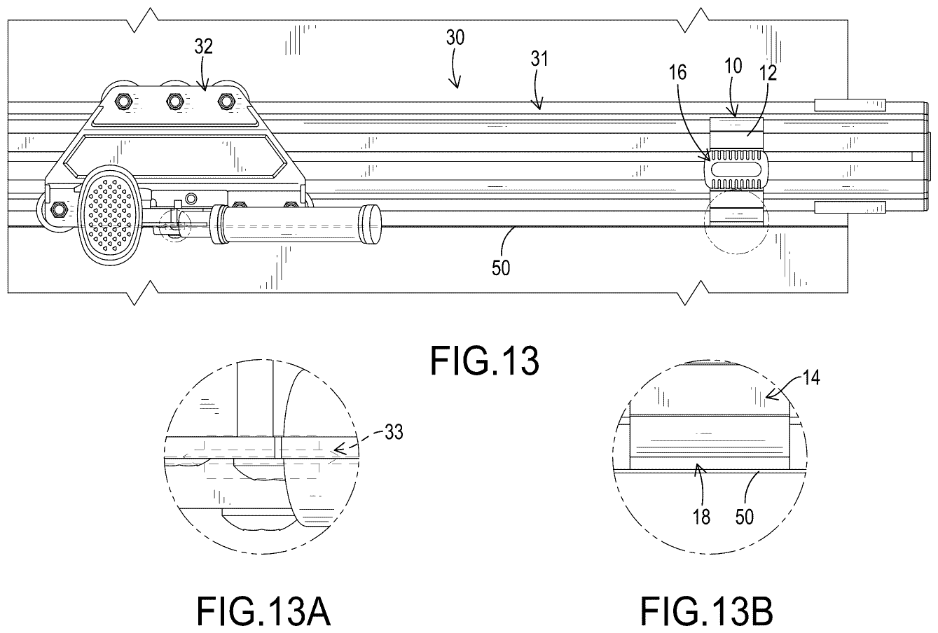

Furthermore, with reference to FIG. 13, the user can hold the cutter 32 to move relative to the track base 31, then the cutting wheel 33 is moved with the cutter 32 and contacts a top face of the processed sintered stone 40. With reference to FIGS. 13 and 13A, a cutting line 50 is formed on the top face of the processed sintered stone 40 by the cutting wheel 33. Furthermore, with reference to FIG. 13B, the cutting line 50 is aligned with the external side face 181 of the reference board 18 of each one of the two measuring seats 10. After the above operations, the processed sintered stone 40 can be cut to an accurate size.

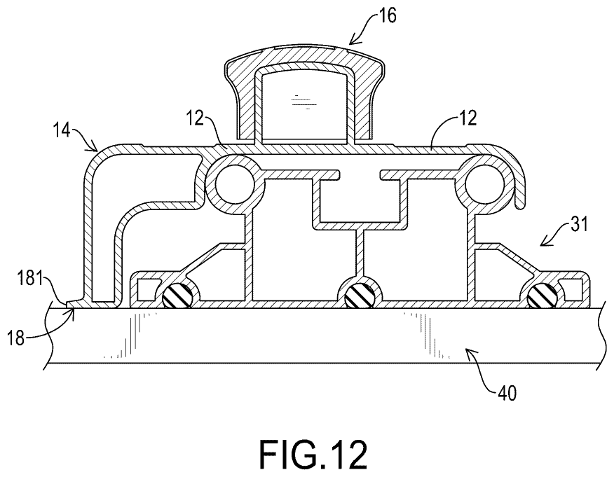

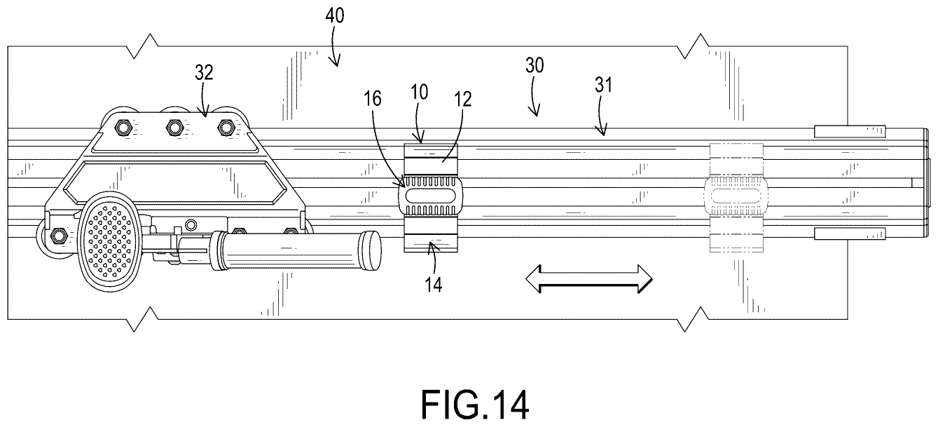

Additionally, with reference to FIGS. 12 and 14, each one of the two measuring seats 10 is disposed on the track base 31 by the two engaging arms 12 engaging with the track base 31. Then the user can adjust the position of each one of the two measuring seats 10 relative to the track base 31 by pushing the pushing stem 16, and this allows the user to flexibly and conveniently measure the cutting size of the processed sintered stone 40 via the two measuring seats 10. Furthermore, the measuring seat 10 is provided in a bridge-like manner over and across the track base 31, which not only allows the positioning arm 14 of the measuring seat 10 to be elastic, but also reduces cost of manufacture, and can greatly reduce the overall weight of the present invention, allowing users to transport and store it conveniently.

According to the above-mentioned structural relationships and features of the measuring seat 10 for a sintered stone cutting machine of the present invention, in use, the user can measure the cutting size of the processed sintered stone 40 via the external side face 181 of the reference board 18 of each one of the two measuring seats 10 since the external side face 181 of the reference board 18 of each one of the two measuring seats 10 is aligned with the cutting edge of the cutting wheel 33, and does not have to measure the cutting edge of the cutting wheel 33, which not only allows for convenient and accurate measurement of the cutting size, but also prevents the user from being injured due to contact with the cutting edge of the cutting wheel 33, greatly improving the safety of use.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A measuring seat for a sintered stone cutting machine, the measuring seat configured to dispose on a sintered stone cutting machine having a track base and a cutter with a cutting wheel, the measuring seat movably disposed on the track base at a side of the cutter and comprising:
a positioning arm located on a side of the track base same as the cutting wheel and having
a reference board formed on a free end of the positioning arm and having an external side face;
wherein an imaginary extension line of the external side face of the reference board of the measuring seat is in a straight line with a cutting edge of the cutting wheel.

2. The measuring seat for a sintered stone cutting machine as claimed in claim 1, wherein
the measuring seat has
two engaging arms connected to each other, extended in opposite directions, and connected to the track base; and
the positioning arm of the measuring seat is connected to one of the two engaging arms of the measuring seat, and extends outwardly and downwardly adjacent to a bottom of the track base.

3. The measuring seat for a sintered stone cutting machine as claimed in claim 2, wherein the measuring seat has a pushing stem disposed on a top of the measuring seat between the two engaging arms.

4. The measuring seat for a sintered stone cutting machine as claimed in claim 3, wherein the pushing stem has multiple notches formed on an outer side of the pushing stem.

5. The measuring seat for a sintered stone cutting machine as claimed in claim 1, wherein the pushing stem has multiple notches formed on an outer side of the pushing stem.

6. The measuring seat for a sintered stone cutting machine as claimed in claim 5, wherein the pushing stem has multiple notches formed on an outer side of the pushing stem.

7. The measuring seat for a sintered stone cutting machine as claimed in claim 1, wherein the measuring seat is arranged in a bridge-like manner over and across the track base to allow the positioning arm to be elastic.

8. The measuring seat for a sintered stone cutting machine as claimed in claim 2, wherein the measuring seat is arranged in a bridge-like manner over and across the track base to allow the positioning arm to be elastic.

9. The measuring seat for a sintered stone cutting machine as claimed in claim 3, wherein the measuring seat is arranged in a bridge-like manner over and across the track base to allow the positioning arm to be elastic.

10. The measuring seat for a sintered stone cutting machine as claimed in claim 4, wherein the measuring seat is arranged in a bridge-like manner over and across the track base to allow the positioning arm to be elastic.

11. The measuring seat for a sintered stone cutting machine as claimed in claim 5, wherein the measuring seat is arranged in a bridge-like manner over and across the track base to allow the positioning arm to be elastic.

12. The measuring seat for a sintered stone cutting machine as claimed in claim 6, wherein the measuring seat is arranged in a bridge-like manner over and across the track base to allow the positioning arm to be elastic.
